(19) United States
(12) Patent Application Publication
(10) Pub. No.: US 2026/0252038 A1
(43) Pub. Date: Aug. 27, 2026

(54) INFORMATION PROCESSOR AND INFORMATION PROCESSING METHOD

(71) Applicant: MURATA MACHINERY, LTD., Kyoto-shi, Kyoto (JP)

(72) Inventor: Yuuya HAGINO, Kyoto-shi (JP)

(21) Appl. No.: 19/472,834

(22) PCT Filed: Apr. 5, 2024
(86) PCT No.: PCT/JP2024/014076

§ 371 Date: Oct. 6, 2025

(30) Foreign Application Priority Data
May 22, 2023 (JP) 2023-083898

(51) Int. Cl. G05B 13/02

(52) U.S. Cl. CPC G05B 13/024

(57) ABSTRACT

An information processor usable in a press machine capable of bending multiple types of components with dies arranged in one direction includes a creator configured or programmed to create die setting data including positions and types of the dies in a press machine, and an outputter configured or programmed to output the die setting data created by the creator. The creator is configured or programmed to include a commonizer to commonize the die usable to bend two or more specific components among multiple types of components, and a die data creator configured or programmed to create first die setting data, which is the die setting data for the die that is commonized, and second die setting data for the die used to bend the components other than the specific components.

### BACKGROUND OF THE INVENTION

### 1. Field of the Invention

The present invention relates to information processors and information processing methods.

### 2. Description of the Related Art

A press machine clamps a workpiece between an upper die and a lower die, which are metal dies, and performs press machining such as bending on the workpiece. In the press machine, multiple dies are arranged along one direction. The operator moves to the position of a designated die (machining position) among the multiple dies arranged in the press machine and performs a press operation at that position to perform the press machining on a component. Typically, the dies arranged in the press machine are defined by die layout data (for example, see Japanese Unexamined Patent Application, First Publication No. 2021-16868). The die layout data is created by an information processor usable in the press machine.

### SUMMARY OF THE INVENTION

When performing press machining for multiple types of components, the information indicating which die among the multiple dies arranged in one direction is to be used for press machining is set by the press machine as die layout data for each component. It is therefore conceivable that the operator frequently changes the machining position when performing press machining operations for multiple types of components, which may lead to a reduced operation efficiency.

Example embodiments of the present invention provide information processors and information processing methods each capable of preventing a reduction in operation efficiency of press operations performed with a press machine.

An information processor according to an example embodiment of the present invention is an information processor usable in a press machine capable of bending multiple types of components with dies arranged in one direction, the information processor including a creator configured or programmed to create die setting data including positions and types of the dies arranged in the press machine, and an outputter configured or programmed to output the die setting data created by the creator, wherein the creator is configured or programmed to include a commonizer configured or programmed to commonize the die usable to bend two or more specific components among the multiple types of the components, and a die data creator configured or programmed to create first die setting data, which is the die setting data for the die that is commonized, and second die setting data, which is the die setting data for the die usable to bend the components other than the two or more specific components.

An information processing method according to an example embodiment of the present invention is an information processing method usable in a press machine capable of bending multiple types of components with dies arranged in one direction, the information processing method including creating die setting data including positions and types of the dies attached to the press machine, and outputting the die setting data created, wherein the step of outputting the die setting data created includes commonizing the die usable to bend two or more of the components that are specific among the multiple types of the components, and creating first die setting data, which is the die setting data for the die that is commonized, and second die setting data, which is the die setting data for the die usable to bend the components other than the components that are specific.

According to the information processors and the information processing methods according to example embodiments of the present invention, for specific components, bending is performed at the same machining position, the operator's movement path is shortened, and confusion over machining position is reduced or prevented, and it is thus possible to reduce or prevent a reduction in operation efficiency.

In the information processor of the above example embodiment, components that are specific may be those that undergo bending in all bending steps in a state of being open in the one direction. According to such a configuration, components that are not subject to restrictions on the length in one direction of the die usable to bend can be grouped as specific components and bent using a common die, and it is thus possible to prevent a reduction in operation efficiency.

In the information processor of the above example embodiment, the commonizer may select all of the components that undergo bending in all bending steps in a state of being open in the one direction, from among the multiple types of the components, and commonize the die usable to bend the components selected. All of the components that are not subject to restrictions on the length in one direction of the die usable to bend can be bent using a single die, and it is thus possible to prevent a reduction in operation efficiency. In the information processor of the above example embodiment, the commonizer may commonize the die usable to bend two or more of the components other than the components that are specific, and the die data creator may create the second die setting data that includes a position and a type of the die commonized. According to such a configuration, it is possible to prevent a reduction in operation efficiency.

In the information processor of the above example embodiment, a dimension in the one direction of the die commonized by the commonizer may be equal to or greater than the dimension in the one direction that is longest among the multiple components selected. In the information processor of the above example embodiment, the press machine may have a range in which the dies can be arranged, and the die commonized by the commonizer may be arranged at a center position in the one direction of the range. According to such a configuration, the shared die is positioned in a center position, and thus the accuracy of bending in the press machine is stabilized.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a front elevation view showing an example of a press machine according to the present example embodiment of the present invention.

FIG. 2 is a block diagram of the press machine according to the present example embodiment of the present invention.

FIG. 3 is a diagram showing an example of a hardware configuration of an information processor according to the present example embodiment of the present invention.

FIG. 4 is a diagram showing an example of multiple types of components according to the present example embodiment of the present invention.

FIG. 5 is a functional block diagram of a processor according to the present example embodiment of the present invention.

FIG. 6 is a diagram for describing first die setting data according to the present example embodiment of the present invention.

FIG. 7 is a diagram for describing second die setting data according to the present example embodiment of the present invention.

FIG. 8 is a flowchart of a method for creating die setting data according to the present example embodiment of the present invention.

FIG. 9 is a diagram showing a die layout in a case where die setting data is created by a method that does not use an example embodiment of the present invention.

FIG. 10 is a diagram showing a machining position to which an operator moves in the case of the die layout of FIG. 9.

FIG. 11 is a flowchart of an information processing method according to the present example embodiment of the present invention.

### DETAILED DESCRIPTION OF THE EXAMPLE EMBODIMENTS

Hereinafter, the present invention will be described with reference to example embodiments. However, the present invention is not limited to the following example embodiments, and not all combinations of elements or features described in the example embodiments are essential. In the drawings, the same or similar elements or features are denoted by the same reference signs, and redundant descriptions may be omitted. The shape and size of the elements in the drawings may be exaggerated for the purpose of clearer description.

The positions and orientations of components may be described with reference to an XYZ Cartesian coordinate system. In this XYZ Cartesian coordinate system, the X direction and Y direction are horizontal directions, and the Z direction is a vertical direction.

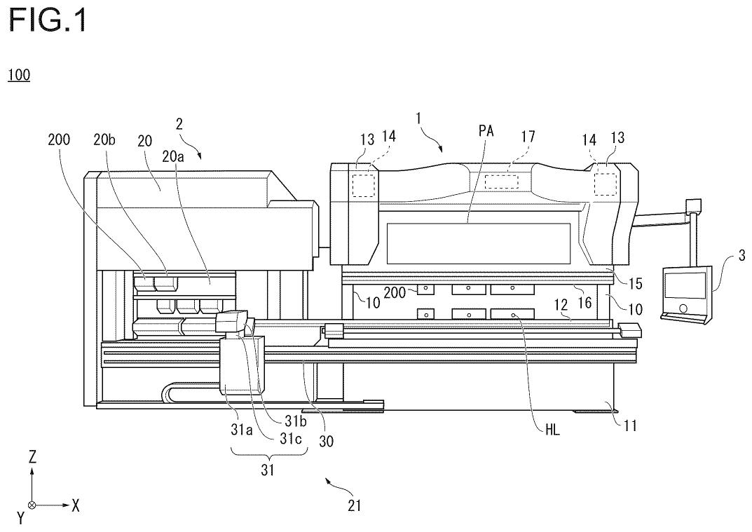

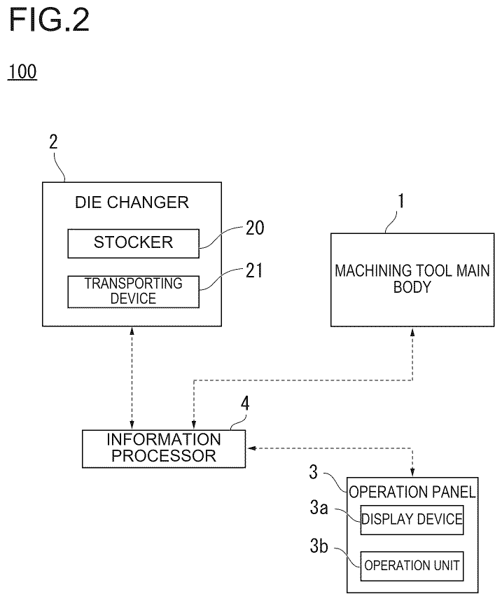

FIG. 1 is a front elevation view showing an example of a press machine 100 according to the present example embodiment. FIG. 2 is a block diagram of the press machine 100 according to the present example embodiment. The press machine 100 is capable of bending multiple types of components PS using dies 200 arranged in one direction (for example, the X direction). Here, “multiple types” refers, for example, to differences in the shapes of components PS. For example, differences in the shapes of components PS may include at least one of the following: whether a flange is present on the component PS, and differences in the position where the flange is located. The press machine 100 is, for example, a press brake capable of creating a component by bending a flat workpiece. In the present example embodiment, the press machine 100 is described as an example of a press brake, but the present invention is not limited to this example. For example, the press machine 100 may perform press-cutting (also referred to as punch machining) on a workpiece, or may perform mold machining other than bending.

As shown in FIG. 1 and FIG. 2, the press machine 100 includes a machining tool main body 1, a die changer 2, an operation panel 3, and an information processor 4.

In the machining tool main body 1, the front side in the −Y direction is the working area for the operator. Dies 200 are attached to the machining tool main body 1. A die 200 may be, for example, an upper die, a lower die, or both. In the following description, a die 200 includes an upper die and a lower die. The operator arranges a workpiece at a predetermined position from the front side of the machining tool main body 1. The machining tool main body 1 then clamps the workpiece, which has been arranged at the predetermined position, between the upper die and the lower die, thus performing bending on the workpiece.

The machining tool main body 1 includes a main body frame 10, a table 11, a lower die guide rail 12, side covers 13, drivers 14, a ram 15, an upper die guide rail 16, and a projector 17. The main body frame 10 defines an outer framework of the press machine 100. The table 11 is attached to the front side of the main body frame 10, and fixes the lower die guide rail 12.

The lower die guide rail 12 is provided, for example, on an upper surface of the table 11 and guides the lower die (not shown in the drawings) along the +X direction (transportation direction). The lower die can move while being guided by the lower die guide rail 12, and is fixed at an arbitrary position. The machining tool main body 1 includes, for example, a back gauge (not shown in the drawings) that positions the workpiece by bringing it into contact therewith in the ±Y direction.

The side covers 13 are provided above both side portions of the main body frame 10 in the ±X direction. Each side cover 13 is arranged so as to cover the upper area of the side portions of the ram 15 in the ±X direction.

The drivers 14 are supported by the main body frame 10 and are provided as a pair, one on the left and one on the right. The pair of driving devices 14 cause the ram 15 to move (ascend and descend) in the Z direction. Each of the drivers 14 may include, for example, a mechanism that raises and lowers the ram 15 by rotating a ball screw or a nut with an electric motor or the like, or a mechanism that raises and lowers the ram 15 using a hydraulic cylinder device or a pneumatic cylinder device. The drivers 14 are controlled by the information processor 4.

The ram 15 is supported on the main body frame 10 by the guide (not shown in the drawings) of the main body frame 10 so as to be able to ascend and descend. The ram 15 is raised and lowered by the drivers 14 and approaches or moves away from the lower die on the table 11.

To a lower portion of the ram 15 there is attached an upper die guide rail 16. The upper die guide rail 16 is provided along the ±X direction. The upper die guide rail 16 guides the upper die being transported in the ±X direction. The upper die guide rail 16 can support the upper die while suspending it therefrom.

The upper die is fixed to the ram 15 at a predetermined position on the upper die guide rail 16. When held at an arbitrary position on the upper die guide rail 16, the upper die is arranged so that a cutting edge, which is a lower end thereof, faces a recess (not shown in the drawings) of the lower die and, at the same time, the cutting edge is arranged along the ±X direction. The upper die fixed to the ram 15 ascends or descends together with the ram 15. Multiple upper dies held on the upper die guide rail 16 may have the same dimension in the ±X direction, or upper dies of different dimensions in the ±X direction may be combined for use. In the press machine 100, the upper die descends toward the lower die as the ram 15 descends and the workpiece is clamped between the upper die and the lower die to perform bending on the workpiece.

The projector 17 is provided on the machining tool main body 1 and projects an image onto a projection area PA, which includes at least a portion of the ram 15, to assist with each step in the bending operation. The image is intended to advise the operator of the position at which the bending should be performed for the workpiece, and how the workpiece should be oriented against the back gauge (not shown in the drawings). For example, among the multiple dies 200 attached to the machining tool main body 1, the die 200 usable to bend may differ depending on the workpiece. For each workpiece and each bending step, the operator checks the image displayed in the projection area PA to determine at which position (hereinafter, referred to as the “machining position”) the machining will actually be performed. Then, the operator performs bending on the workpiece by clamping it between the upper die and the lower die at the determined machining position to create a component PS of the desired shape.

The die changer 2 changes the dies 200 in the machining tool main body 1. The die changer 2 includes a stocker 20 and a transporting device 21.

The stocker 20 accommodates one or more dies 200. The transporting device 21 transports the die 200 between the machining tool main body 1 and the stocker 20. The transporting device 21 transports, for example, a die 200 in the stocker 20 to the upper die guide rail 16 or the lower die guide rail 12 of the machining tool main body 1 and arranges it in the machining tool main body 1. The transporting device 21 can also transport a die 200 arranged in the machining tool main body 1 to the stocker 20. The transporting device 21 includes, for example, a transportation guide 30 and a transporter 31.

The transportation guide 30 guides the transporter 31 in the ±X direction. The transportation guide 30 is provided on the table 11, for example. The transportation guide 30 extends linearly along the ±X direction. The transportation guide 30 is parallel to the upper die guide rail 16, for example. The transporter 31 can move along the ±X direction while being guided by the transportation guide 30. The transporter 31 can arrange the die 200 in the press machine 100 and transport the die 200 that is attached to the press machine 100 to the stocker 20. The transporter 31 includes, for example, a slider 31a, an elevation rod 31b, and a head 31c.

The slider 31a can be reciprocated by a driver not shown in the drawings in the ±X direction along the transportation guide 30. The elevation rod 31b is provided on the slider 31a so as to be able to be raised or lowered, and can be raised and lowered along the ±Z direction by a driver not shown in the drawings. The head 31c is provided at an upper end of the elevation rod 31b, and is raised or lowered along the ±Z direction as the elevation rod 31b is raised or lowered. With such a configuration, the transporter 31 can arrange the head 31c at any position in the ±X direction and the ±Z direction within the movable range of the transportation guide 30 and the elevation rod 31b. The head 31c is provided with a rod-shaped body (not shown in the drawings). The head 31c can hold the die 200 by advancing and retracting the rod-shaped body in the ±Y direction and inserting it into a hole HL in the die 200.

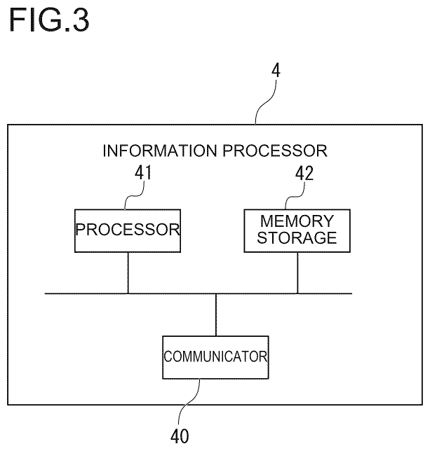

The information processor 4 comprehensively controls operations of the press machine 100. FIG. 3 is a diagram showing an example of a hardware configuration of the information processor 4 according to the present example embodiment. As shown in FIG. 3, the information processor 4 is configured or programmed to include a communicator 40, a processor 41, and a memory storage 42. The memory storage 42 may be an external memory storage, rather than being part of the configuration of the information processor 4. When the memory storage 42 is an external memory storage, the information processor 4 is connected to the memory storage 42 via wired or wireless communication and transmits and receives information to and from the memory storage 42.

The communicator 40 is a communication interface configured or programmed to communicate with external devices. The communication network through which the communicator 40 performs communication may be a wired network, a wireless network, or both.

The processor 41 is configured or programmed to comprehensively control operations of the press machine 100. As an example, the processor 41 reads out a program or the like stored in the memory storage 42 to control the operation of the die changer 2 or to control display of the press machine 100. The display of the press machine 100 may be, for example, a display device 3a of the operation panel 3 or the projection area PA. The processor 41 includes, for example, at least one of a CPU (Central Processing Unit), MPU (Microprocessing Unit), or a GPU (Graphics Processing Unit).

Examples of the memory storage 42 include non-volatile memory, such as ROM (Read Only Memory), HDD (Hard Disk Drive), and SSD (Solid State Drive). The program executed by the processor 41 may be provided by a computer-readable storage medium, or may be provided from an external device via a wired or wireless communication network. The provided program is stored in the memory storage 42 and executed by the processor 41.

Examples of the computer-readable storage medium may include electronic storage media, magnetic storage media, optical storage media, electromagnetic storage media, and semiconductor storage media. More specific examples of the computer-readable storage medium may include diskettes, hard disks, random access memories (RAM), read-only memories (ROM), erasable programmable read-only memories (EPROM or flash memory), electrically erasable programmable read-only memories (EEPROM), static random access memories (SRAM), compact disc read-only memories (CD-ROM), digital versatile discs (DVD), Blu-ray (RTM) discs, memory sticks, and integrated circuit cards.

The memory storage 42 stores bending data for bending components PS, for each type of the component PS. The bending data includes a program that defines the operation of the machining tool main body 1 in each bending step for creating a component PS. For example, the bending data includes data related to the sequence of each bending step of the bending operation and bending in each bending step, and data of the die 200 usable to bend (hereinafter, referred to as “used die data”). The used die data is information indicating which of the dies 200, attached to the machining tool main body 1 based on die setting data, is used to perform bending on the workpiece. The bending data may also include information such as the movement conditions of the ram 15 in each bending step (for example, start position, speed, end position).

The memory storage 42 stores the die setting data for the die 200 to be attached to the machining tool main body 1, for each workpiece. The die setting data includes the type of the die to be attached to the machining tool main body 1, the position at which the die is to be attached, and the orientation in which the die 200 is to be attached. For example, in the case where three different dies 200 are arranged in the machining tool main body 1, the die setting data includes information on the types of the three dies 200, information on the attachment positions of the three dies 200 and the attachment orientations of the three dies 200. In other words, the die setting data indicates which die 200 is positioned at which position in the machining tool main body 1. This die setting data may be stored in the memory storage 42 in association with each bending data, or may be included as a part of bending data. A single set of die setting data related to the dies 200 that are arranged in the machining tool main body 1 at the same time. The processor 41 selects the dies 200 to be arranged in the machining tool main body 1 on the basis of the die setting data, and arranges the selected dies 200 in the machining tool main body 1 using the die changer 2.

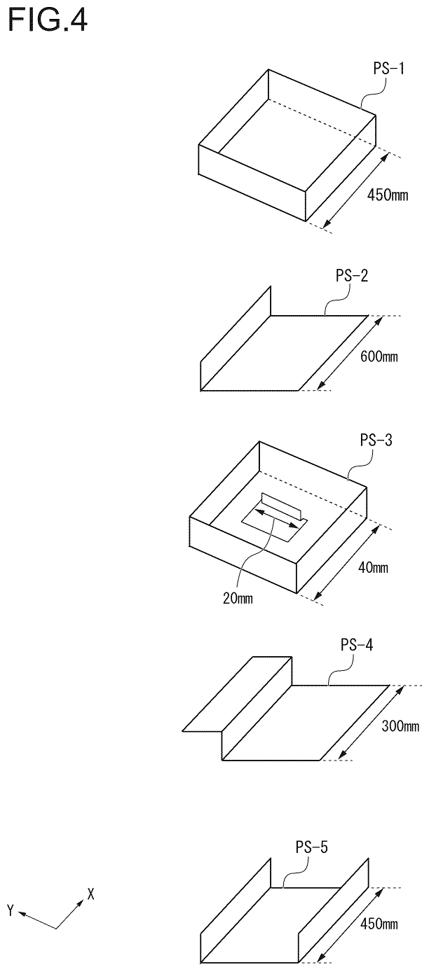

FIG. 4 is a diagram showing an example of multiple types of components PS. The example in FIG. 4 shows five components PS-1 to PS-5. The component PS-1 is a component that is created by performing box bending. The component PS-2 is a component that is created by performing L-shaped bending. The component PS-3 is a component that is created by performing complex bending. The component PS-4 is a component that is created by performing Z-shaped bending. The component PS-5 is a component that is created by performing U-shaped bending (channel-shaped bending).

Thus, the multiple types of components PS-1 to PS-5 are components that are created through different types of bending. The bending data and die setting data for each of the components PS-1 to PS-5 are preliminarily stored in the memory storage 42. In other words, the memory storage 42 stores, as data corresponding to the component PS-1, bending data for performing box bending and die setting data for performing the box bending. The memory storage 42 stores, as data corresponding to the component PS-2, bending data for performing L-shaped bending and die setting data for performing the L-shaped bending. The memory storage 42 stores, as data corresponding to the component PS-3, bending data for performing complex bending and die setting data for performing the complex bending. The memory storage 42 stores, as data corresponding to the component PS-4, bending data for performing Z-shaped bending and die setting data for performing the Z-shaped bending. The memory storage 42 stores, as data corresponding to the component PS-5, bending data for performing U-shaped bending and die setting data for performing the U-shaped bending.

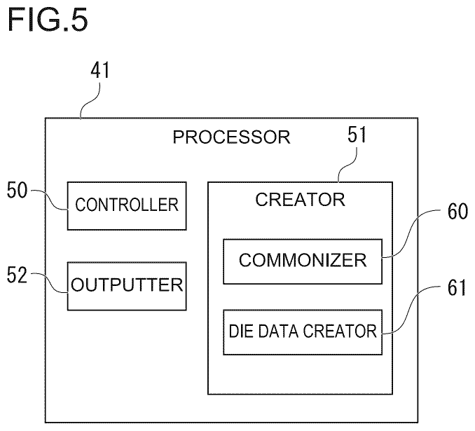

The functional units of the processor 41 of the present example embodiment will be described, with reference to FIG. 5. FIG. 5 is a functional block diagram of the processor 41 according to the present example embodiment. The processor 41 is configured or programmed to include a controller 50, a creator 51, and an outputter 52. The controller 50, the creator 51, and the outputter 52 are implemented by the processor 41 executing a program stored in the memory storage 42.

The controller 50 is configured or programmed to control the die changer 2. The controller 50 is configured or programmed to control the die changer 2, and cause the die changer 2 to arrange dies 200 in the machining tool main body 1 on the basis of die layout information. In other words, in response to an instruction from the controller 50, the die changer 2 arranges one or more dies 200 in the machining tool main body 1 to achieve the arrangement of dies 200 indicated by die setting data. When a bending instruction is received from the operator, the controller 50 is configured or programmed to cause the driver 14 to operate to execute bending.

The creator 51 is configured or programmed to commonize a die 200 for two or more specific components PS among the multiple types of components PS. The creator 51 then creates first die setting data for performing press machining with the commonized die 200, and second die setting data for press machining components PS other than the specific components PS with one or more dies 200. The die 200 that is commonized by the creator 51 (commonizer 60 described later) may be referred to as common die.

When press machining of specific components PS is performed, a common die is arranged in the machining tool main body 1 according to first die setting data, and when press machining of components PS other than the specific components is performed, one or more dies 200 are arranged in the machining tool main body 1 according to second die setting data. The dies 200 may be arranged in the machining tool main body 1 by the die changer 2, or may be arranged in the machining tool main body 1 by the operator. For example, the creator 51 includes a commonizer 60 and a die data creator 61.

The commonizer 60 commonizes a die 200 usable to bend two or more of specific components PS among the multiple types of the components PS. This commonized die 200 is the common die mentioned above. Specifically, the commonizer 60 commonizes a die 200 usable to bend two or more of the specific components PS among the multiple types of components PS. These specific components PS are those that undergo bending in all bending steps in a state of being open in one direction. In other words, the commonizer 60 selects all of the components PS that undergo bending in all bending steps in a state of being open in one direction (specific components), from among the multiple types of the components PS. The state of being open refers, for example, to a state where no flange is present. The commonizer 60 commonizes a die 200 usable to bend the selected components PS.

Components that undergo bending in all bending steps in the state of being open in one direction can be bent using any die 200. On the other hand, for components that are not open in the one direction in any bending step, the flange interferes with the die 200, which imposes a restriction on the length in the one direction of the die 200 usable to bend. The commonizer 60 selects components (specific components) that are not subject to this restriction from among the multiple types of components PS. In other words, the commonizer 60 distinguishes the multiple types of components PS into those that are not subject to the above restriction and those that are. The commonizer 60 commonizes the die 200 usable to bend the components not subject to the above restriction.

The die data creator 61 creates first die setting data, which is the die setting data for the die (common die) commonized by the commonizer 60. The die data creator 61 creates second die setting data, which is the die setting data for one or more dies 200 usable to bend components PS other than the specific components PS. It should be noted that the second die setting data created by the die data creator 61 may be a single set or multiple sets. The one or more dies 200 included in the second die setting data may also be commonized by the commonizer 60. For example, all or at least two of the multiple dies 200 in the second die setting data may be dies 200 commonized by the commonizer 60. The dimension of the common die in the one direction is set to be equal to or greater than, for example, the longest dimension in the one direction among the multiple components selected by the commonizer 60.

The common die may, for example, be a die defined by bending data (for example, die setting data) for machining the component that has the longest dimension in the one direction among the multiple components (specific components) selected by the commonizer 60. In the first die setting data, the common die may be set to be arranged at the center position CP of the machining tool main body 1. This center position CP is the center position in the one direction within the range in which dies 200 can be arranged in the press machine 100.

The die data creator 61 executes a first updating process to update the die setting data corresponding to the specific components to first die setting data and to update the bending data to data for bending with the common die. The die data creator 61 executes a second updating process to update die setting data corresponding to components other than the specific components to second die setting data and to update the bending data to bending data for bending with the dies 200 set in the second die setting data.

Hereinafter, a specific example of a method for creating die setting data for the multiple types of components PS-1 to PS-5 will be described. The commonizer 60 selects all of the components PS that undergo bending in all bending steps in a state of being open in one direction (specific components), from among the multiple types of components PS. In the example shown in FIG. 4, the box bending step for the component PS-1 involves a step of performing bending where a flange is located on one side of the one direction. The complex bending step for the component PS-3 involves a step of performing bending where a flange is located on one or both sides of the one direction. Consequently, to perform box bending and complex bending, a restriction arises such that the dimension in the one direction of the die 200 used for this bending must not allow it come into contact with the component's flange.

On the other hand, for L-shaped bending, Z-shaped bending, and U-shaped bending, there is no bending step in which bending is performed with a flange located on a side of one direction in all steps. Therefore, to perform L-shaped bending, Z-shaped bending, and U-shaped bending, there is no restriction that the dimension in the one direction of the die 200 usable to bend must not allow it to come into contact with the component's flange. As a result, the commonizer 60 selects the components PS-2, PS-4, and PS-5 from among the multiple types of components PS-1 to PS-5 as components that undergo bending in the state of being open in the one direction in all bending steps.

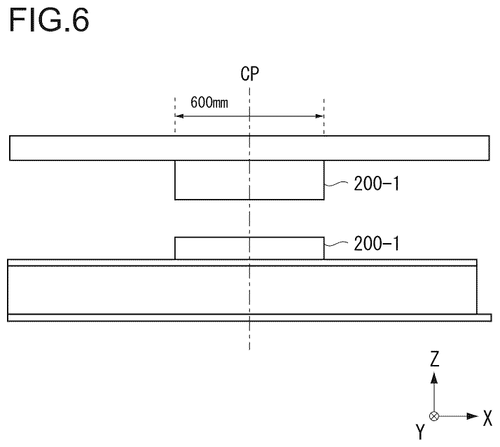

The commonizer 60 commonizes a die capable of bending the component PS-2, component PS-4, and component PS-5 selected. Here, the component PS-2 has a dimension in the one direction of 600 mm, the component PS-4 has a dimension in the one direction of 300 mm, and the component PS-5 has a dimension in the one direction of 450 mm. In such a case, as an example, the commonizer 60 selects, as the common die, a die 200 that has a dimension equal to or longer than that of the component PS-2, being the component with the longest dimension. FIG. 6 is a diagram for describing first die setting data. In the example shown in FIG. 6, the commonizer 60 selects a die 200-1 with a dimension in the one direction of 600 mm as the common die. Then, the die data creator 61 creates first die setting data for arranging the selected die 200-1 at the center position CP of the machining tool main body 1. As the first updating process, the die setting data for the component PS-2, component PS-4, and component PS-5 is updated to first die setting data, and their respective bending data is updated to bending data for machining with the common die.

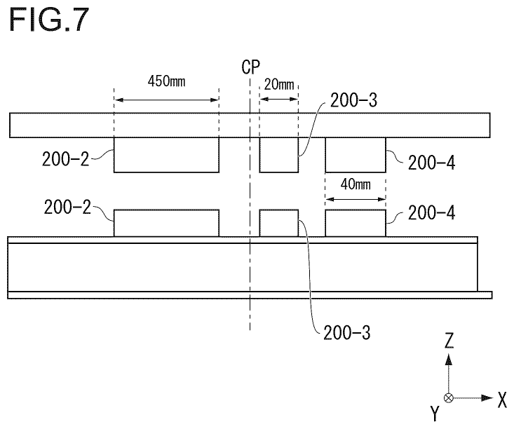

Next, the die data creator 61 creates second layout data for machining the component PS-1 and component PS-4. FIG. 7 is a diagram for describing second die setting data. Specifically, the die data creator 61 selects the dies 200 to be used for box bending of the component PS-1 and complex bending of the component PS-3. The die data creator 61 selects a die 200-2 for box bending of the component PS-1, and selects dies 200-3 and 200-4 for complex bending of the component PS-3. Then, the die data creator 61 creates second die setting data for arranging the die 200-2 for box bending of the component PS-1 and the dies 200-3 and 200-4 for complex bending of the component PS-3 along the one direction in the machining tool main body 1.

The second die setting data is defined so that, for example, the dies are arranged sequentially from left to right as the die 200-2, the die 200-3, and the die 200-4, with the center of the range from the left end of the leftmost die 200-2 to the right end of the rightmost die 200-4 being positioned at the center position CP. As the second die setting data, the die setting data for the component PS-1 is updated to second die setting data, and the bending data is updated to bending data for machining with the die 200-2, which is arranged according to the second die setting data. Also, as the second die setting data, the die setting data for the component PS-3 is updated to second die setting data, and the bending data is updated to bending data for machining with the die 200-3 and the die 200-4, which are arranged according to the second die setting data.

When creating the component PS-2, component PS-4, and component PS-5, the die changer 2 or the operator arranges the die 200-1, which is the common die, in the machining tool main body 1 according to the first die setting data. The operator then creates the component PS-2, component PS-4, and component PS-5 by performing L-shaped bending, Z-shaped bending, and U-shaped bending using the die 200-1. Similarly, when creating the component PS-1 and component PS-3, the die changer 2 or the operator arranges the die 200-2, die 200-3, and die 200-4 in the machining tool main body 1 according to the second die setting data. The operator then creates the component PS-1 and component PS-3 by performing box bending using the die 200-2 and complex bending using the die 200-3 and die 200-4.

The outputter 52 can output the first die setting data and the second die setting data created by the creator 51. For example, the outputter 52 can output the first die setting data and the second die setting data created by the creator 51 to a display of the press machine 100 via the communicator 40, or to an external information terminal. Such an information terminal may be, for example, a computer, a portable terminal, or a wearable terminal.

The output of die setting data (first die setting data and second die setting data) from the outputter 52 may be triggered by accepting a predetermined operation from the operator, or by the creator 51 completing the creation of first die setting data and second die setting data. The output of die setting data from the outputter 52 includes, for example, transmitting and storing the die setting data in the memory storage 42 within the information processor 4, in addition to outputting die setting data to an external device. The term “storing” encompasses both the first updating process and the second updating process.

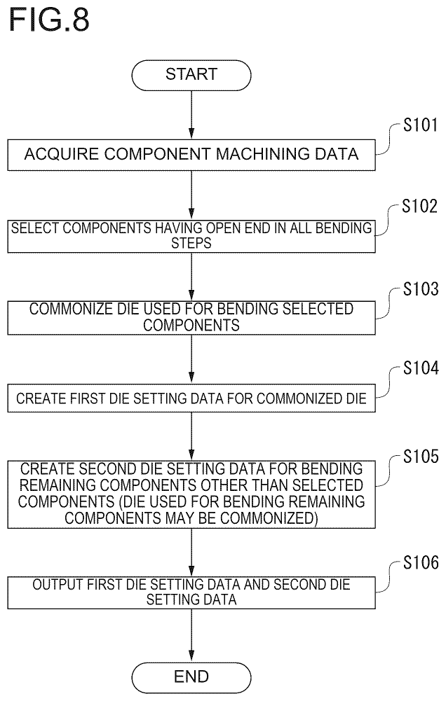

Hereinafter, an example of a method for creating die setting data according to the present example embodiment will be specifically described. FIG. 8 is a flowchart of the method for creating die setting data according to the present example embodiment. First, the commonizer 60 acquires machining data for multiple types of components PS (Step S101). The commonizer 60 makes reference to the acquired information of the multiple types of components PS and selects all components among them that are configured with an open end in one direction in all bending steps (Step S102). An open end refers, for example, to a state where no flange is present.

The commonizer 60 commonizes a die 200 capable of bending the selected commonizers PS (Step S103). For example, the commonizer 60 commonizes by making reference to the die setting data of the component PS with the longest dimension in the one direction among the selected multiple components PS, and selecting the die 200 set in that die setting data as the common die. The die data creator 61 creates first die setting data for arranging the commonized die, that is, the selected common die, at the center position CP (Step S104).

The die data creator 61 creates second die setting data for performing bending of the remaining components PS, which were not selected by the commonizer 60, from among the multiple types of components PS (Step S105). For example, the die data creator 61 makes reference to the die setting data of the remaining components PS and creates second die setting data for arranging the dies 200 set in that die setting data. Here, the commonizer 60 may commonize the die for bending two or more of the remaining components PS within the second die setting data. This commonization method is, for example, similar to the die commonization method usable in creating the first die setting data. For example, the die for bending all of the remaining components PS may be commonized, or the die for bending a subset of the remaining components PS may be commonized. The die data creator 61 may create second die setting data that includes the position and type of the die 200 for bending the remaining two or more components PS, commonized by the commonizer 60.

In the case where there are multiple remaining components PS, the die data creator 61 makes reference to each die setting data and creates second die setting data for arranging the dies 200 set in each die setting data sequentially in one direction. It should be noted that in the case where there are duplicate dies 200 among those set in each die setting data, the die data creator 61 may create second die setting data for arranging these duplicate dies 200 as a single die 200 in the machining tool main body 1. The outputter 52 outputs the first die setting data and the second die setting data created by the die data creator 61 to the display of the press machine 100 (Step S106). In Step S106, the first updating process and the second updating process may be executed. The first updating process and the second updating process may be executed when a predetermined operation is performed by the user after Step S106.

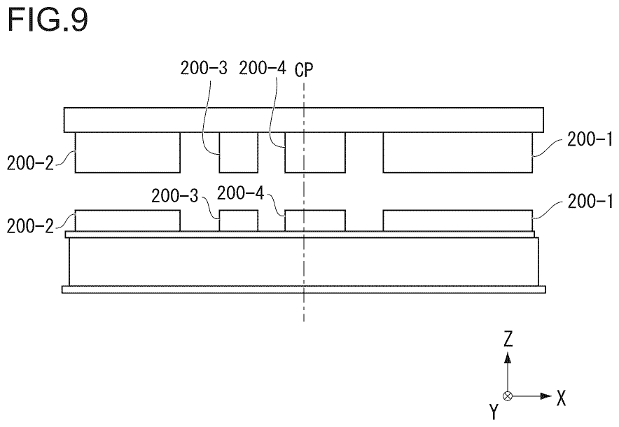

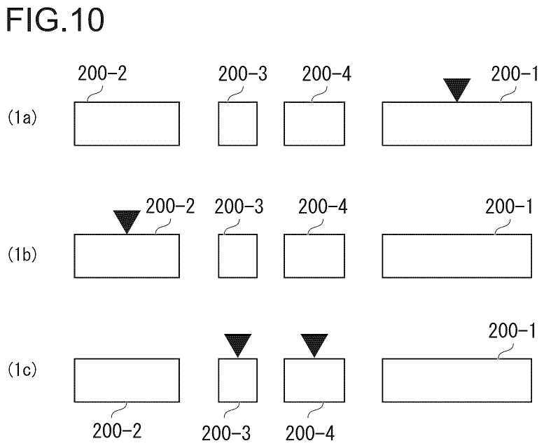

Hereinafter, the advantageous effects of the present example embodiment will be described. For example, if die setting data for bending the component PS-1 to component PS-5 were created by a method not using an example embodiment of the present invention, a layout of dies 200 as shown in FIG. 9 could be considered. When the dies 200 are arranged according to the layout exemplified in FIG. 9, it is conceivable that the operator would perform bending in the following sequence (1a), (1b), (1c) as shown in FIG. 10. FIG. 10 is a diagram showing each machining position to which the operator moves when performing bending in the sequence (1a), (1b), (1c) with the die layout exemplified in FIG. 9. The triangles in FIG. 10 represent the operator's machining positions.
(1a): Create component PS-2 by performing L-shaped bending with die 200-1, which is positioned at the far right.
(1b): Move to the far left and create components PS-1, PS-4, and PS-5 by performing box bending, Z-shaped bending, and U-shaped bending with die 200-2.
(1c): Move to the center machining position and create component PS-3 by performing complex bending with die 200-3 and die 200-4.

However, to execute bending in the sequence (1a), (1b), (1c), the operator must frequently change machining positions, which reduces operation efficiency. In bending operations that involve frequent changes in machining positions, the operator might become confused about where to move next for the bending operation.

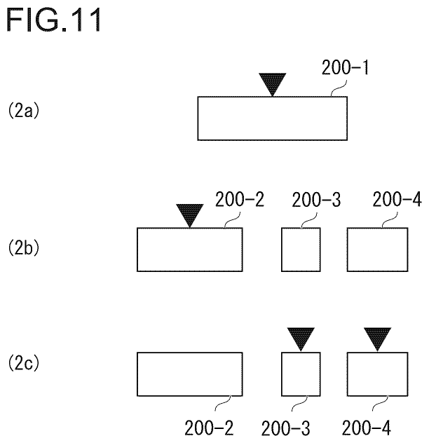

In the present example embodiment, the creator 51 generates first die setting data that enables bending of components at any machining position using a single shared die, and second die setting data for machining the remaining components. As a result, as shown in FIG. 11, the operator performs bending in the following sequence (2a), (2b), (2c). FIG. 11 is a diagram showing each machining position to which the operator moves when performing bending in the sequence (2a), (2b), (2c) with the die layout according to the present example embodiment. The triangles in FIG. 11 represent the operator's machining positions.
(2a): Create components PS-2, PS-4, and PS-5 using die 200-1, the shared die arranged according to the first die setting data.
(2b): Die 200-2 to die 200-4 are arranged according to the second die setting data, and the operator creates component PS-1 using die 200-2.
(2c): The operator moves to the center machining position and creates component PS-3 using die 200-3 and die 200-4.

As a result, in the present example embodiment exemplified in FIG. 11, the operator's movement path may be shorter compared to the die layout shown in FIG. 10, thereby preventing a reduction in operation efficiency. Furthermore, in the present example embodiment, instead of performing bending for all components PS with the same die layout, bending is executed by distinguishing between a die: bending multiple components PS with a shared die 200 and a die layout for bending components PS that cannot be bent with the shared die using dies 200 other than the shared die. Therefore, the operator's confusion over machining position becomes less likely when performing bending for multiple types of components PS. Since the shared die is arranged at the center position CP, the accuracy of bending operations in the press machine 100 is stabilized.

The above example embodiments may have any of the following configurations.

### Configuration 1

An information processor 4 usable in a press machine 100 capable of bending multiple types of components PS with dies 200 arranged in one direction, the information processor 4 including a creator 51 configured or programmed to create die setting data including positions and types of the dies 200 arranged in a press machine 100, and an outputter 52 configured or programmed to output the die setting data created by the creator 51, wherein the creator 51 is configured or programmed to include a commonizer 60 configured or programmed to commonize the die 200 usable to bend two or more specific components PS of the components PS, and a die data creator 61 configured or programmed to create first die setting data, which is the die setting data for the die that is commonized, and second die setting data for the die 200 usable to bend the components PS other than the two or more specific components PS.

### Configuration 2

The information processor 4 according to configuration 1, wherein the two or more specific components PS undergo bending in all bending steps in a state of being open in the one direction.

### Configuration 3

The information processor 4 according to configuration 1 or 2, wherein the commonizer 60 is configured or programmed to select all of the components PS that undergo bending in all bending steps in a state of being open in the one direction, from among the multiple types of the components PS, and commonizes the die usable to bend the components PS selected.

### Configuration 4

The information processor 4 according to any one of configurations 1 to 3, wherein a dimension in the one direction of the die 200 commonized by the commonizer is equal to or greater than a dimension in the one direction that is longest among the multiple components PS selected.

### Configuration 5

The information processor according to any one of configurations 1 to 4, wherein the commonizer 60 is configured or programmed to commonize the die 200 usable to bend the two or more specific, and the die data creator is configured or programmed to create the second die setting data that includes a position and a type of the die 200 commonized.

### Configuration 6

The information processor 4 according to any one of configurations 1 to 5, wherein the press machine 100 has a range in which the dies 200 can be arranged, and the die 200 commonized by the commonizer is arranged at a center position in the one direction of the range.

Example embodiments of the present invention have been described above. However, the technical scope of the present invention is not limited to the description of the above example embodiments. It is also apparent to those skilled in the art that various modifications or improvements can be added to the above example embodiments. It is also apparent from the scope of claims that the present invention also encompasses one or more of such modifications or improvements. One or more of the requirements described in the above example embodiments may be omitted in some cases. One or more of the requirements described in the above example embodiments may be combined where appropriate. The order of executing procedures shown in the above example embodiments can be implemented in an arbitrary order unless the result of the previous procedure is usable in the following procedure. While operations in the above example embodiments have been described with expressions such as “first”, “next”, and “subsequently” for the sake of convenience, the operations need not always be implemented in that order.

The contents of Japanese Patent Application No. 2023-083898 and all documents cited in the detailed description of the present invention are incorporated herein by reference to the extent permitted by law.

While example embodiments of the present invention have been described above, it is to be understood that variations and modifications will be apparent to those skilled in the art without departing from the scope and spirit of the present invention. The scope of the present invention, therefore, is to be determined solely by the following claims.

1-7. (canceled)

8. An information processor usable in a press machine capable of bending multiple types of components with dies arranged in one direction, the information processor comprising:
a creator configured or programmed to create die setting data including positions and types of the dies arranged in the press machine; and
an outputter configured or programmed to output the die setting data created by the creator; wherein
the creator is configured or programmed to include:
a commonizer configured or programmed to commonize the die usable to bend two or more specific components among the multiple types of the components; and
a die data creator configured or programmed to create first die setting data, which is the die setting data for the die that is commonized, and second die setting data, which is the die setting data for the die usable to bend the components other than the two or more specific components.

9. The information processor according to claim 8, wherein the two or more specific components undergo bending in all bending steps in a state of being open in the one direction.

10. The information processor according to claim 8, wherein the commonizer is configured or programmed to select all of the components that undergo bending in all bending steps in a state of being open in the one direction, from among the multiple types of the components, and commonize the die usable to bend the components selected.

11. The information processor according to claim 8, wherein a dimension in the one direction of the die commonized by the commonizer is equal to or greater than a dimension in the one direction that is longest among the multiple components selected.

12. The information processor according to claim 8, wherein
the commonizer is configured or programmed to commonize the die usable to bend two or more of the components other than the two or more specific components; and
the die data creator is configured or programmed to create the second die setting data that includes a position and a type of the die commonized.

13. The information processor according to claim 8, wherein
the press machine has a range in which the dies can be arranged; and
the die commonized by the commonizer is arranged at a center position in the one direction of the range.

14. An information processing method usable in a press machine capable of bending multiple types of components with dies arranged in one direction, the information processing method comprising:
creating die setting data including positions and types of the dies attached to the press machine; and
outputting the die setting data created; wherein
the outputting includes:
commonizing the die usable to bend two or more specific components among the multiple types of the components; and
creating first die setting data, which is the die setting data for the die that is commonized, and second die setting data, which is the die setting data for the die usable to bend the components other than the two or more specific components.
